(19) United States
(12) Patent Application Publication
(10) Pub. No.: US 2013/0321933 A1
(43) Pub. Date: Dec. 5, 2013

(54) IMAGING LENS APPARATUS

(71) Applicants: Shih-Yuan Chang, Changhua (TW); Feng-Chao Chung, Changhua (TW); Hung-Wen Lee, Changhua (TW)

(72) Inventors: Shih-Yuan Chang, Changhua (TW); Feng-Chao Chung, Changhua (TW); Hung-Wen Lee, Changhua (TW)

(21) Appl. No.: 13/487,278

(22) Filed: Jun. 4, 2012

(51) Int. Cl. G02B 13/18

(52) U.S. Cl. 359/717

(57) ABSTRACT

An imaging lens apparatus comprises two lenses with refractive function, from the object side to the image side: a first lens which is a positive meniscus lens with a convex object-side surface, an aperture; and a second lens which is a negative meniscus lens with a concave object-side lens. Both surfaces of said first and second lens are aspheric, and the imaging lens apparatus satisfy the following equations: 1.35<N₁<1.57; 1.60<N₂<1.65; V₁≧50; V₂<30; wherein, N₁ is the refractivity of the first lens, N₂ is the refractivity of the second lens, V₁ is the abbe number of the first lens, and V₂ is the abbe number of the second lens.

### BACKGROUND OF THE INVENTION

1. Field of the Invention

The present invention generally relates to a photographing lens apparatus, and more particularly to a photographing lens apparatus having two optical lenses and suitable for small photographing device.

2. The Related Art

With the growth of the consumer electronic markets, the request for photographing module is also increasing. Particularly to the camera equipped in photograph phone, tablet computer and laptop, optical lens almost become the mainstream accessories. However, in order to be installed in the mounting body which itself becomes more and more slim, small and light, the photographing module must be compact and inexpensive accordingly.

For the purpose of being compact, the total length of the imaging lens apparatus (from the object-side surface of the first lens to the imaging plane) should be shorten. For the purpose of being inexpensive, the quantity of lens should be as few as possible and the produce process should be simplified. However, the photograph module still needs to provide a high-quality picture because the image quality and the pixels of picture have become important considerations for customers to choose.

In order to effectively reduce the total length of the lens apparatus for retaining the high image quality, two-lenses imaging lens apparatus proved to be the best solution. Such as a compact imaging lens assembly comprising two lens elements disclosed in U.S. Pat. No. 7,525,741. However, a frontal aperture stop setup will generate too much unwanted light entry, which increases the sensitivity reaction to the optical system, and makes it difficult to control the yield in manufacturing process.

To satisfy all of requests above, the imaging lens apparatus need to be improved.

### SUMMARY OF THE INVENTION

An object of the present invention is to provide a two-lenses imaging lens apparatus in small size with aspheric surface which can eliminate the optical aberrations and improve the image quality.

To reach such purpose, the imaging lens apparatus in this invention comprises two lens with refractive function, positioned in order from the object-side to the image-side:

A first lens, the first lens is a positive meniscus lens with two aspheric surface where the object-side surface of the first lens is convex; an aperture (an opening through which light travels that determines the cone angle of a bundle of rays that come to a focus in the image plane), the aperture is positioned next to the first lens; and a second lens, the second lens is a negative meniscus lens with two aspheric surface. The imaging lens apparatus further satisfies the following conditions:

−9>f₁*f₂>−15

Wherein, f₁ is the focal length of the first lens, f is the combined focal length of the imaging lens apparatus, and f₂ is the focal length of the second lens.

Furthermore, the imaging lens apparatus satisfies the following constrains:

1.35<N₁<1.57

1.60<N₂<1.65

V₁≧50

V₂<30

Wherein, N₁ is the refractive index (a dimensionless number that describes how light, or any other radiation, propagates through the medium) of the first lens, N₂ is the refractive index of the second lens, V₁ is the abbe number (a measure of the material's dispersion in relation to the refractive index) of the first lens, and V₂ is the abbe number of the second lens.

In a feasible embodiment, the optical imaging lens apparatus further satisfies the following conditions to optimal the focal balance of each of the lenses and improves the performance of the imaging lens apparatus:

0.65<f₁/f<0.85

−3.7<f₂/f<−2.4

0.2<R₁/f<0.4

−1.3<R₄/f<−1.0

Wherein, f₁ is the focal length of the first lens, f is the combined focal length of the imaging lens apparatus, f₂ is the focal length of the second lens, R₁ is the radius of curvature of the object-side surface of the first lens, and R₄ is the radius of curvature of the image-side surface of the second lens.

In a better embodiment, the imaging lens apparatus satisfies the following conditions:

TTL/ImgC≦0.9

TTL/f<1.2

Wherein, TTL is the distance between the highest point of the object-side surface of the first lens and the imaging plane. ImgC is the diagonal length of the effective pixels of the image sensor.

As described above, the imaging lens apparatus in this invention comprises two lenses with refractive function, allocated from the object side to the image side: the first lens is a positive meniscus lens with a convex object-side surface, an aperture is placed next to the first lens; and a second lens which is a negative meniscus lens with a concave object-side lens is placed next to the aperture. Both surfaces of said first and second lens are aspheric. When both of the first and the second lenses satisfies the predetermined conditions above, the total length of the imaging lens apparatus can be shortened; and be preferable to keep the distortion aberration under 2%, angle of view wider than 60 degree. Accordingly it eliminates optical aberrations, improves the image quality and reduces the produce cost.

### BRIEF DESCRIPTION OF THE DRAWINGS

The present invention will be apparent to those skilled in the art by reading the following description, with reference to the attached drawings, in which:

FIG. 1 shows a cross section of lenses in the imaging lens apparatus of the present invention;

FIG. 2A shows the image formed by incident light from different angle;

FIG. 2B shows various aberrations of the imaging lens apparatus in this invention;

FIG. 3 shows a cross section of lenses in the imaging lens apparatus of the first embodiment;

FIG. 4 shows various aberrations of the imaging lens apparatus of FIG. 3;

FIG. 5 shows a cross section of lenses in the imaging lens apparatus of the second embodiment;

FIG. 6 shows various aberrations of the imaging lens apparatus of FIG. 5;

FIG. 7 shows a cross section of lenses of the imaging lens apparatus of the third embodiment; and

FIG. 8 shows a various aberrations of the imaging lens apparatus of FIG. 7.

### DETAILED DESCRIPTION OF THE PREFERRED EMBODIMENT

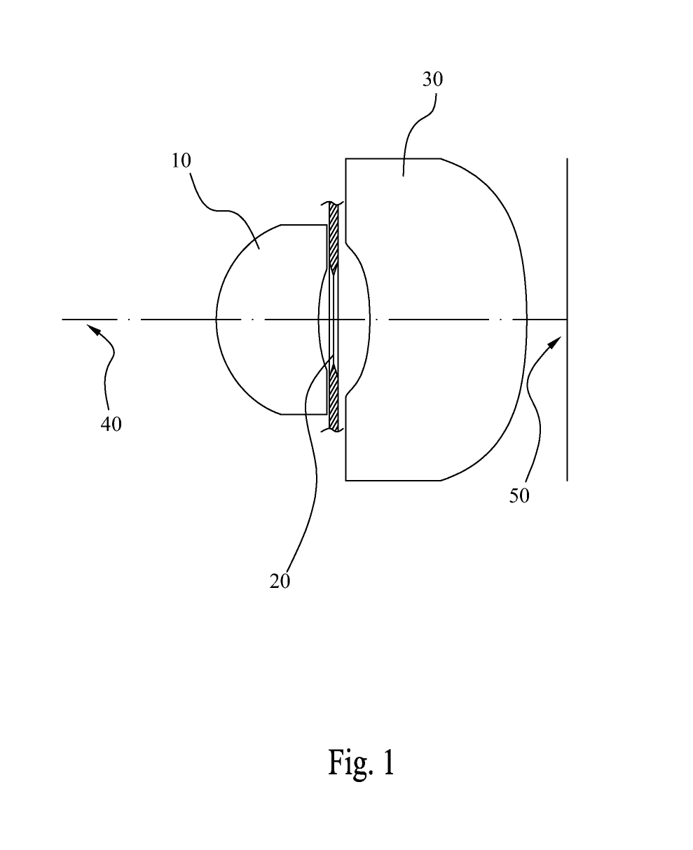

With reference to FIG. 1, the imaging lens apparatus in accordance with the present invention is shown. The imaging lens apparatus comprises from the object-side 40 to the imaging-side 50:

A first lens 10 with positive refractive function, the object-side surface of the first lens 10 is convex and the image-side surface is concave; both side of the first lens 10 are aspheric. An aperture 20; a second lens 30, the second lens 30 is a negative meniscus lens with a concave object-side surface, and both side of the second lens 30 are aspheric. Furthermore, the imaging lens apparatus satisfies the following conditions:

−9>*f₂>−15

1.35<N₁<1.57

1.60<N₂<1.65

V₁≧50

V₂<30

Wherein, f₁ is the focal length of the first lens, f is the combined focal length of the imaging lens apparatus, f₂ is the focal length of the second lens, N₁ is the refractive index of the first lens 10, N₂ is the refractive index of the second lens 30, V₁ is the abbe number of the first lens 10, and V₂ is the abbe number of the second lens 30.

The imaging lens apparatus in this invention is a two-lenses imaging lens, the aperture 20 is settled between the first lens 10 and the second lens 30 to eliminate the off-axis aberration, and the first lens 10 and the second lens 30 are both meniscus lenses with two aspheric surface.

In order to optimize the focal balance of each lens and improve the performance of the imaging lens apparatus, the imaging lens apparatus further satisfies the following conditions:

0.65<f₁/f<0.85

−3.7<f₂/f<−2.4

0.2<R₁d<0.4

−1.3<R₄/f<−1.0

Wherein, f₁ is the focal length of the first lens 10, f is the combined focal length of the imaging lens apparatus, f₂ is the focal length of the second lens 30, R₁ is the radius of curvature of the object-side surface of the first lens 10, and R₄ is the radius of curvature of the image-side 50 of the second lens 30.

If f₁/f is lower than the lower limit; the positive refractive power of the first lens 10 will be too large and hard to eliminate the optical aberrations. In opposite, if the value of f₁/f exceeds the upper limit; the positive refractive power of the first lens 10 will be too small and makes the total length of the imaging lens apparatus increase.

If f₂/f exceeds the upper limit; the negative refractive power of the second lens 30 will be too large and makes the dispersion hard to correct, in order to correct the dispersion the positive refractive power of the first lens 10 have to be increased. As a result, the first lens 10 and the second lens 30 have to be assembled with great precision. In opposite, if f₂/f is lower than the lower limit, the negative refractive power of the second lens 30 will be too small and cause the dispersion cannot be corrected properly.

In a better embodiment, the imaging lens apparatus further satisfies the following conditions:

TTL/ImgC≦0.9

TTL/f<1.2

Wherein, TTL is the distance from the highest point of the object-side surface of the first lens 10 to the image plane of the image sensor. ImgC is the diagonal length of the effective pixels of the image sensor. When TTL/f or TTL/ImgC exceeds the upper limit; the imaging lens apparatus will be hard to miniaturize.

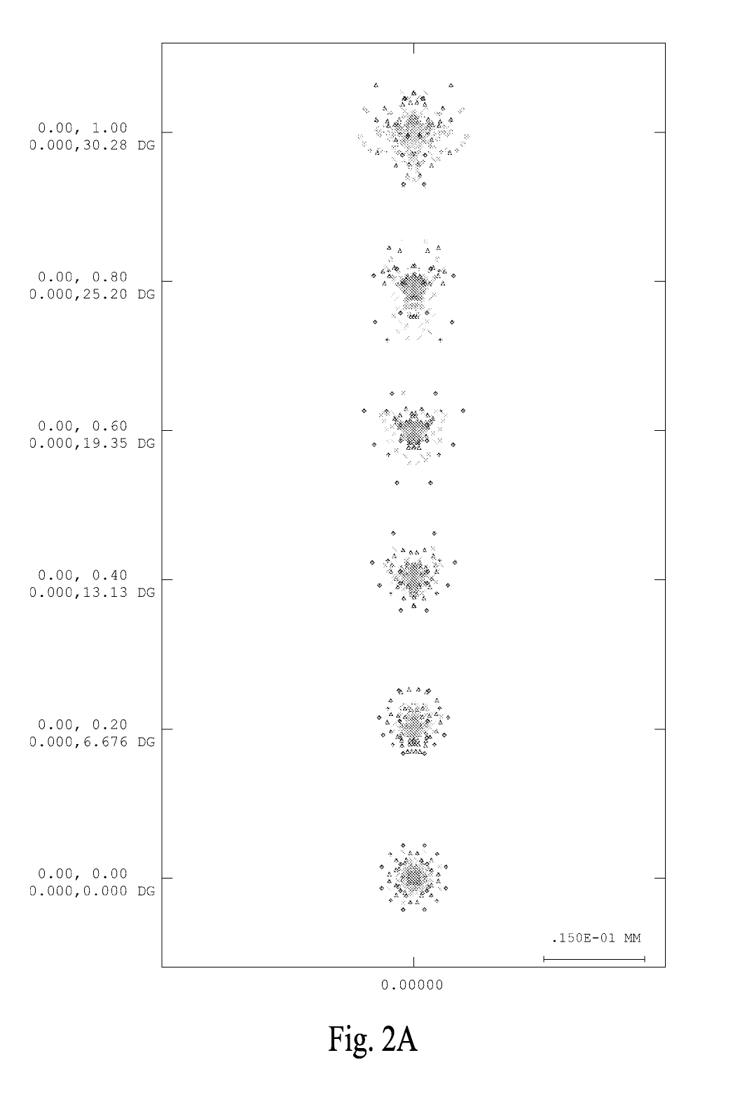

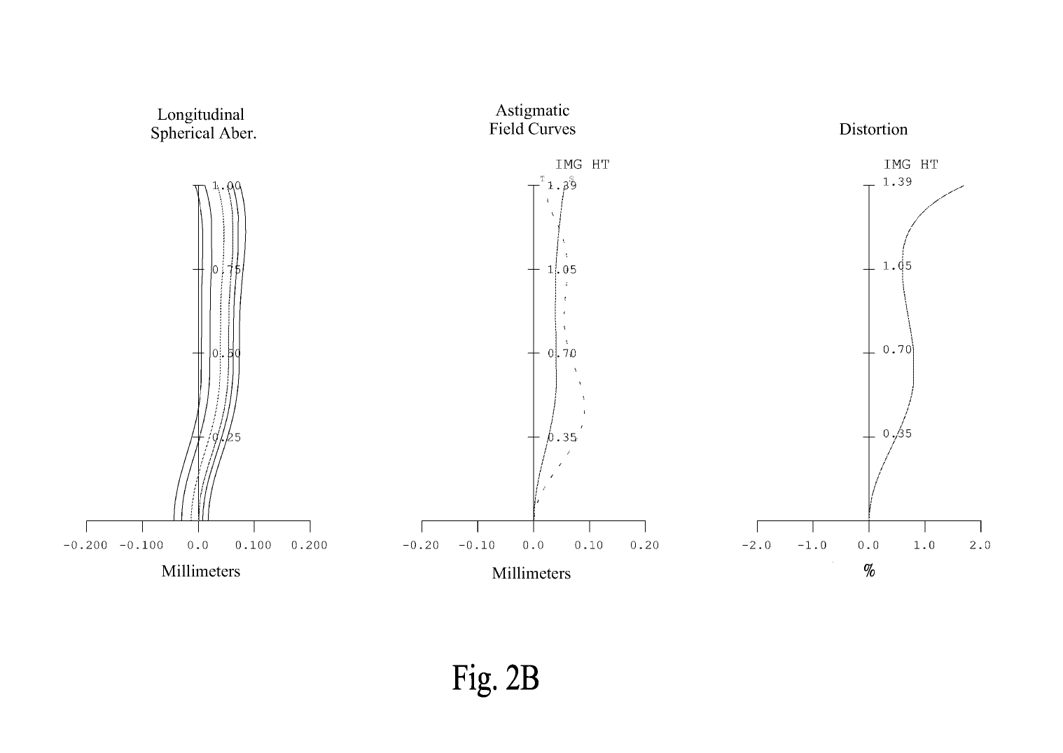

Referring to FIG. 2A and FIG. 2B, these drawings show that the resolution, the spherical aberration, the astigmatism and the distortion aberration can be all controlled in an excellent range.

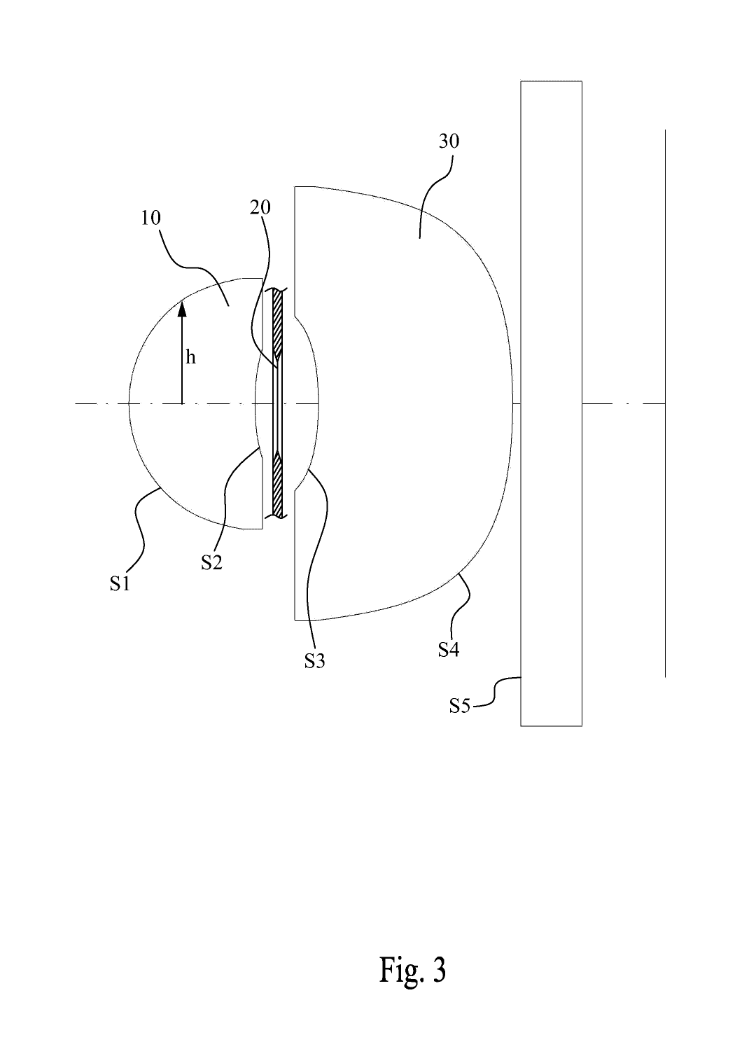

Referring to FIG. 3, in the first embodiment shown in this drawing, F number of the aperture 20 is 2.8, the maximum angle of view is 60.3 degree, the refractive index of the first lens 10 is 1.544, the abbe number of the first lens 10 is 56, f₁/f is 2.27, the refractive index of the second lens 30 is 1.608, the abbe number of the second lens 30 is 26.6, f₂/f is −3.65, R₄/f is −2.12, TTL/ImgC is 0.88 and TTL/f is 1.14.

The radius of curvature and the value of air space of each lenses are listed below:

| | Radius of | |
|---|---|---|
| Surface # | curvature | Air space |
| S1 | 0.6256 | 0.6178 |
| STOP | 1.1636 | 0.3130 |
| S3 | −1.4850 | 0.9537 |
| S4 | −2.5905 | 0.04 |
| S5 | INFINITY | 0.3 |

The aspherical surfaces of the first and the second lens 10, 30 satisfy the following aspheric equation:

$$z = \frac{{ch}^{2}}{1 + \sqrt{( 1 - ( 1 + k ) {c}^{2} {h}^{2} )}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

Wherein, c is the curvature of the lens, h is the vertical distance between the surface of lens and the optical axis, k is the conic constant, and A₄, A₆, A₈, A₁₀, A₁₂, A₁₄ and A₁₆ are aspheric constants of the second order, the fourth order, the sixth order, the eighth order, the tenth order, the twelfth order, the fourteenth order and the sixteenth order. Said conic constant and aspheric constants are listed below:

| Surface # | K | A₄ | A₆ | A₈ |
|---|---|---|---|---|
| S1 | −6.310300 | 2.90008E+00 | −9.31512E+00 | 2.25807E+01 |
| STOP | 5.107026 | 6.51002E−01 | −1.45147E+01 | 2.95330E+02 |
| S3 | 2.166900 | −1.36937E+00 | 1.44407E+01 | −2.51352E+02 |
| S4 | −6.282036 | −1.37135E−01 | −6.92333E−01 | 1.84643E+00 |

| Surface # | A₁₀ | A₁₂ | A₁₄ | A₁₆ |
|---|---|---|---|---|
| S1 | 5.84186E+01 | −4.25417E+02 | 7.19220E+02 | 0.00000E+00 |
| STOP | −1.54475E+03 | −1.43395E+02 | 1.85276E+04 | 0.00000E+00 |
| S3 | 2.05800E+03 | −7.52447E+03 | −2.73095E+03 | 5.44744E+04 |
| S4 | −2.87936E+00 | 1.95796E+00 | −1.31082E−01 | −4.02700E−01 |

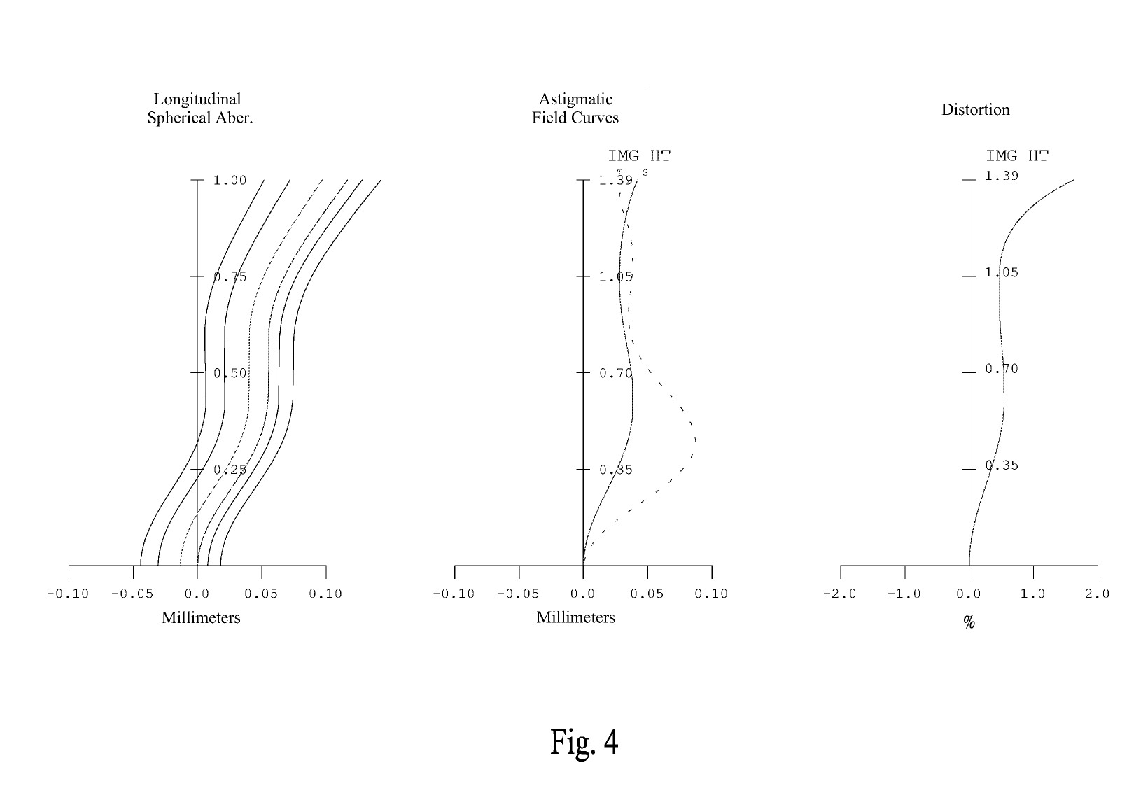

Referring to FIG. 4, this drawing shows that the resolution, the spherical aberration, the astigmatism and the distortion aberration can be all controlled in an excellent range.

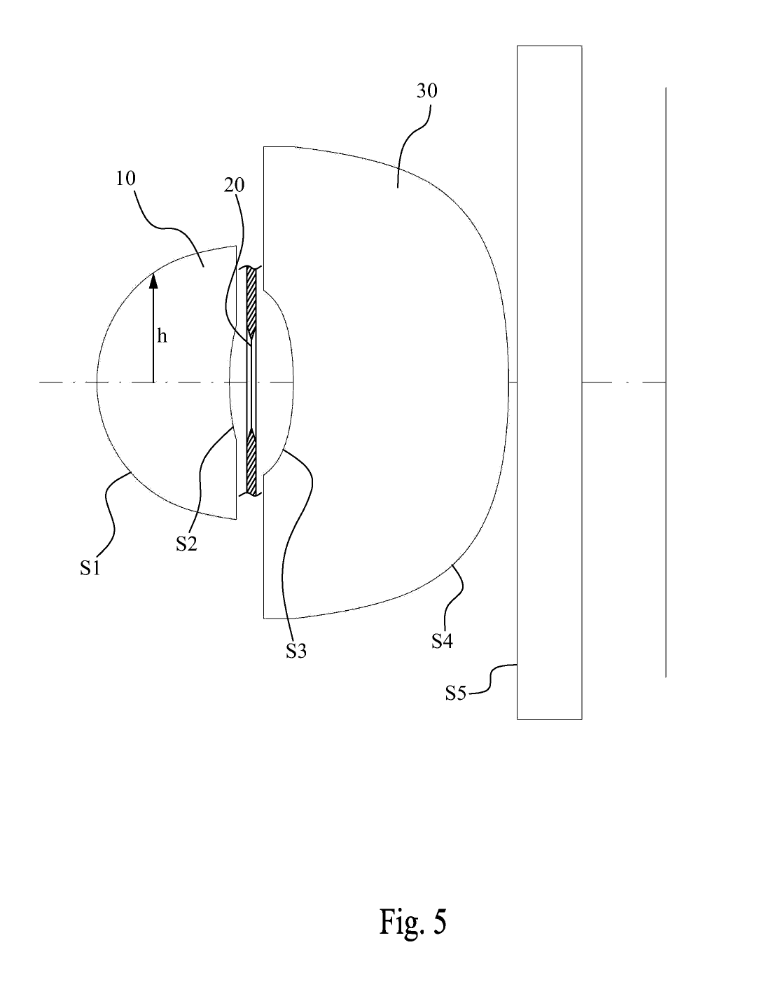

Referring to FIG. 5, in the second embodiment shown in this drawing, F number of the aperture 20 is 2.8, the maximum angle of view is 60.8 degree, effective focal length is 2.323, the refractive index of the first lens 10 is 1.544, the abbe number of the first lens 10 is 56, f₁/f is 0.73, R₁/f is 0.27, the refractive index of the second lens 30 is 1.632, the abbe number of the second lens 30 is 23, f₂/f is −2.91, R₄/f is −1.13, TTL/ImgC is 0.88 and TTL/f is 1.13.

The radius of curvature and the value of air space of each lenses are listed below:

| | Radius of | |
|---|---|---|
| Surface # | curvature | Air space |
| S1 | 0.6271 | 0.6137 |
| STOP | 1.2619 | 0.2954 |
| S3 | −1.3947 | 0.9950 |
| S4 | −2.6342 | 0.04 |
| S5 | INFINITY | 0.3 |

The aspherical surfaces of the first and the second lens 10, 30 satisfy the following aspheric equation:

$$z = \frac{{ch}^{2}}{1 + \sqrt{( 1 - ( 1 + k ) {c}^{2} {h}^{2} )}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

Wherein, c is the curvature of the lens, h is the vertical distance between the surface of lens and the optical axis, k is the conic constant, and A₄, A₆, A₈, A₁₀, A₁₂, A₁₄ and A₁₆ are the aspheric constants of the second order, the fourth order, the sixth order, the eighth order, the tenth order, the twelfth order, the fourteenth order and the sixteenth order. Said conic constant and aspheric constants are listed below:

| Surface # | K | A₄ | A₆ | A₈ |
|---|---|---|---|---|
| S1 | −6.305742 | 2.90575E+00 | −9.33708E+00 | 2.18648E+01 |
| STOP | 4.990371 | 6.13837E−01 | −1.42453E+01 | 2.45396E+02 |
| S3 | 5.790470 | −1.08299E+00 | 1.08173E+01 | −2.19434E+02 |
| S4 | −29.656917 | −2.28623E−01 | −6.01857E−01 | 1.88271E+00 |

| Surface # | A₁₀ | A₁₂ | A₁₄ | A₁₆ |
|---|---|---|---|---|
| S1 | 6.03282E+01 | −4.16352E+02 | 6.84400E+02 | 0.00000E+00 |
| STOP | −1.40084E+03 | −1.43395E+02 | 1.85276E+04 | 0.00000E+00 |
| S3 | 1.91549E+03 | −7.52447E+03 | −2.73095E+03 | 5.44744E+04 |
| S4 | −2.91679E+00 | 1.89806E+00 | −1.39228E−01 | −3.12463E−01 |

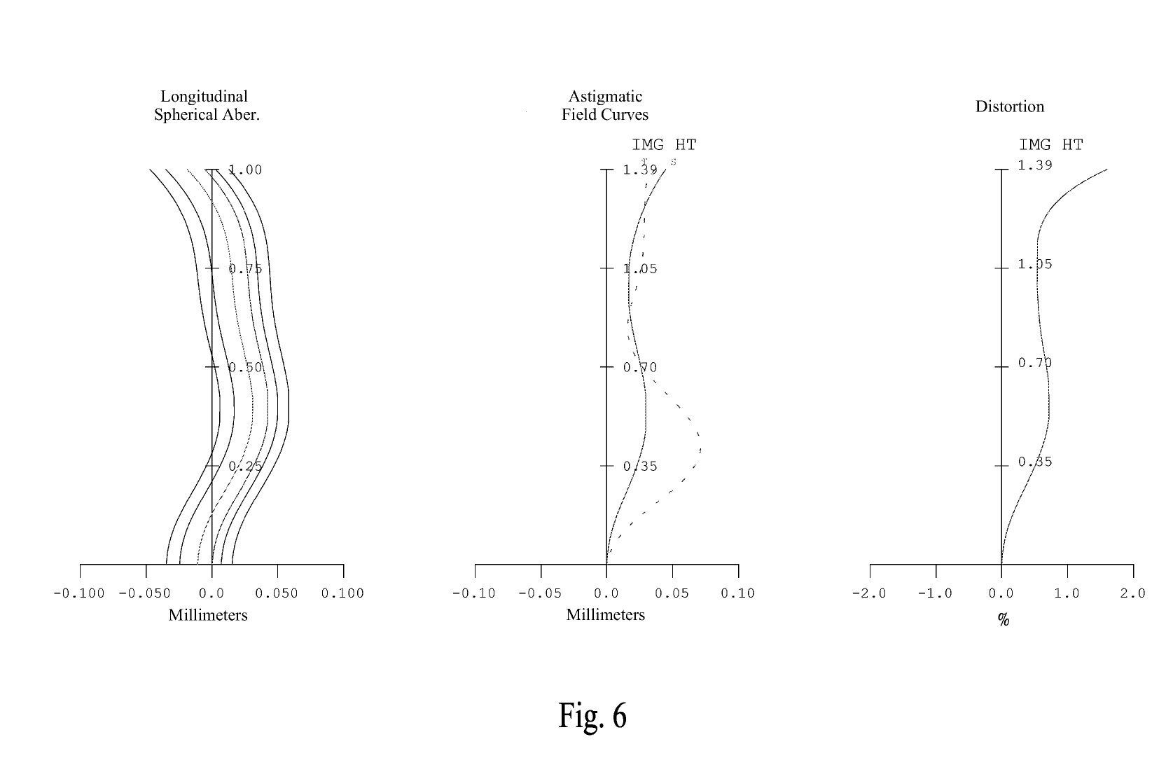

Referring to FIG. 6, this drawing shows that the resolution, the spherical aberration, the astigmatism and the distortion aberration can be all controlled in an excellent range.

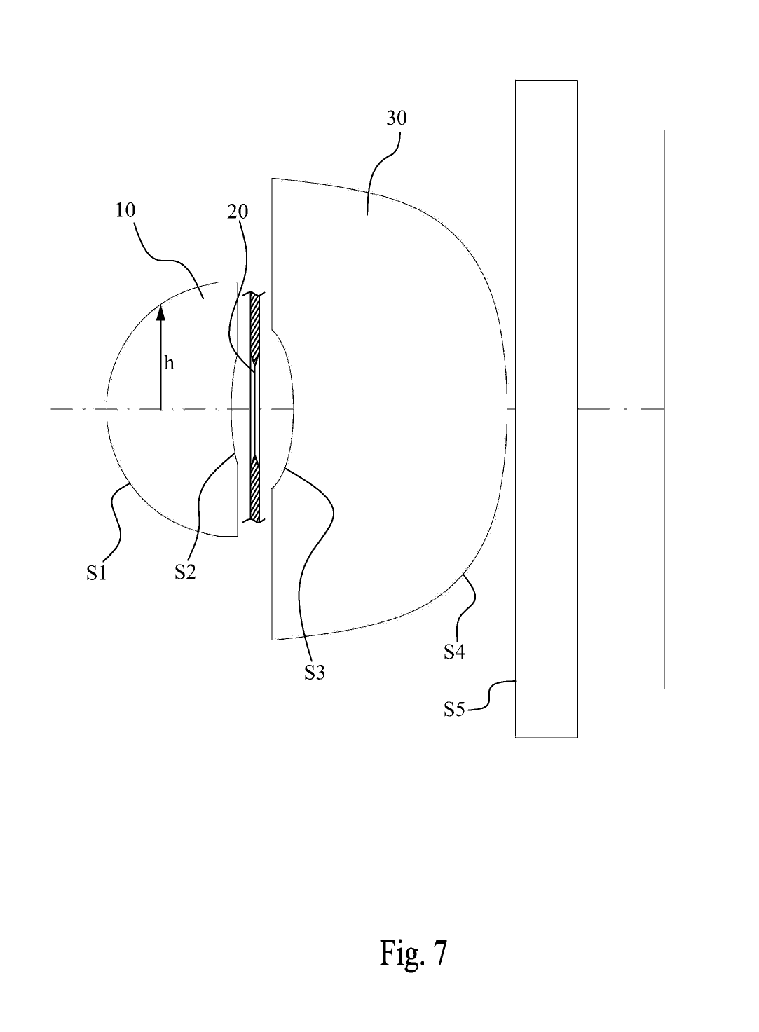

Referring to FIG. 7, in the third embodiment shown in this drawing, F number of the aperture 20 is 2.8, the maximum angle of view is 59.4 degree, effective focal length is 2.358, the refractive index of the first lens 10 is 1.531, the abbe number of the first lens 10 is 50, f₁/f is 0.71, R₁/f is 0.26, the refractive index of the second lens 30 is 1.608, the abbe number of the second lens 30 is 26.6, f₂/f is −2.47, R₄/f is −1.09, TTL/ImgC is 0.90 and TTL/f is 1.14.

The radius of curvature and the value of air space of each lenses are listed below:

| | Radius of | |
|---|---|---|
| Surface # | curvature | Air space |
| S1 | 0.6211 | 0.6003 |
| STOP | 1.3600 | 0.2992 |
| S3 | −1.2644 | 1.0304 |
| S4 | −2.5631 | 0.04 |
| S5 | INFINITY | 0.3 |

The aspherical surfaces of the first and the second lens 10, 30 satisfy the following aspheric equation:

$$z = \frac{{ch}^{2}}{1 + \sqrt{( 1 - ( 1 + k ) {c}^{2} {h}^{2} )}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

Wherein, c is the curvature of the lens, h is the vertical distance between the surface of lens and the optical axis, k is the conic constant, and A₄, A₆, A₈, A₁₀, A₁₂, A₁₄ and A₁₆ are the aspheric constants of the second order, the fourth order, the sixth order, the eighth order, the tenth order, the twelfth order, the fourteenth order and the sixteenth order. Said conic constant and aspheric constants are listed below:

| Surface # | K | A₄ | A₆ | A₈ |
|---|---|---|---|---|
| S1 | −6.070780 | 2.90046E+00 | −9.25264E+00 | 2.21123E+01 |
| STOP | 4.891249 | 6.67303E−01 | −1.51753E+01 | 2.85309E+02 |
| S3 | 8.293647 | −9.73075E−01 | 1.28695E+01 | −2.35441E+02 |
| S4 | −16.014883 | −1.71179E−01 | −6.60155E−01 | 1.91195E+00 |

| Surface # | A₁₀ | A₁₂ | A₁₄ | A₁₆ |
|---|---|---|---|---|
| S1 | 6.07801E+01 | −4.28447E+02 | 7.16657E+02 | 0.00000E+00 |
| STOP | −1.51424E+03 | −1.43395E+02 | 1.85276E+04 | 0.00000E+00 |
| S3 | 2.01149E+03 | −7.52447E+03 | −2.73095E+03 | 5.44744E+04 |
| S4 | −2.92093E+00 | 1.89894E+00 | −1.35783E−01 | −3.02163E−01 |

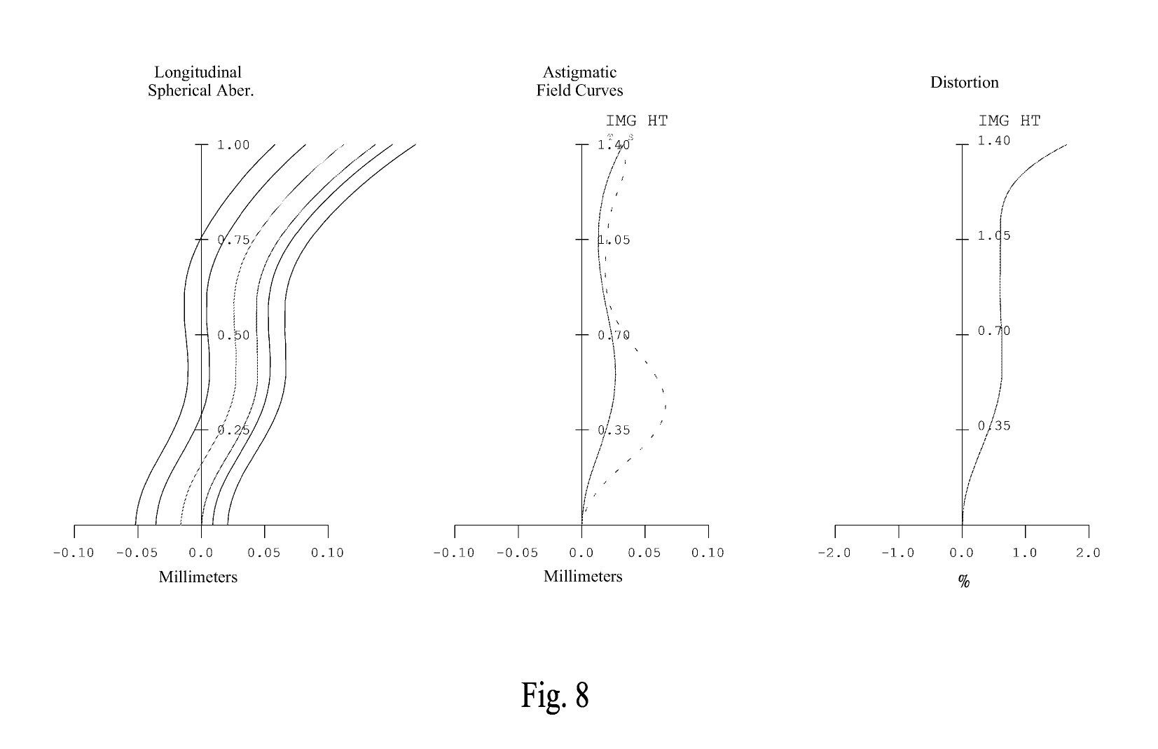

Referring to FIG. 8, this drawing shows that the resolution, the spherical aberration, the astigmatism and the distortion aberration can be all controlled in an excellent range.

As described above, the imaging lens apparatus in this invention comprises two lenses with refractive function, with the allocation from the object side to the image side: a first lens 10 which is a positive meniscus lens with a convex object-side surface, an aperture 20; and a second lens 30 which is a negative meniscus lens with a concave object-side surface. Both surfaces of said first and second lens are aspheric, and when the imaging lens apparatus satisfies the predetermined conditions above the total length of the imaging lens apparatus can be shorten; and ensure the small size lenses to keep the distortion aberration under 2%, angle of view wider than 60 degree. Accordingly it eliminates the optical aberrations, improves the image quality and reduces the produce cost.

What is claimed is:

1. An imaging lens apparatus comprising, positioned in order from an object side to an image side:
a first lens, the first lens is a positive meniscus lens with a convex object-side surface, and both surface of the first lens are aspheric;
an aperture;
a second lens, the second lens is a negative meniscus lens, and both surface of the second lens are aspheric,
wherein the imaging lens apparatus satisfies the following conditions:
−9>f₁*f₂>−15
f₁ is the focal length of the first lens, f is the combined focal length of the imaging lens apparatus, and f₂ is the focal length of the second lens.

2. The imaging lens apparatus as claimed in claim 1, wherein the imaging lens apparatus further satisfies the following conditions:
1.35≦N₁<1.57
1.60<N₂<1.65
wherein, N1 is the refractive index of the first lens, and N2 is the refractive index of the second lens.

3. The imaging lens apparatus as claimed in claim 1, wherein the imaging lens apparatus further satisfies the following conditions:
V₁≧50
V₂<30
wherein, V1 is the abbe number of the first lens, and V2 is the abbe number of the second lens.

4. The imaging lens apparatus as claimed in claim 1, wherein the imaging lens apparatus further satisfies the following conditions:
0.65<f₁/f<0.85
−3.7<f₂/f<−2.4
wherein, f₁ is the focal length of the first lens, f is the combined focal length of the imaging lens apparatus and f₂ is the focal length of the second lens.

5. The imaging lens apparatus as claimed in claim 1, wherein the imaging lens apparatus further satisfies the following conditions:
0.2<R₁/f<0.4
−1.3<R₄/f<−1.0
wherein, f is the combined focal length of the imaging lens apparatus, R₁ is the radius of curvature of the object-side surface of the first lens, and R₄ is the radius of curvature of the image-side surface of the second lens.

6. The imaging lens apparatus as claimed in claim 1, wherein the imaging lens apparatus further satisfies the following conditions:
TTL/ImgC≦0.9
TTL/f<1.2
wherein, TTL is the distance from the highest point of the object-side surface of the first lens to the imaging plane of the image sensor, and ImgC is the diagonal length of effective pixels of the image sensor.
